(19) United States
(12) Patent Application Publication
(10) Pub. No.: US 2015/0264950 A1
(43) Pub. Date: Sep. 24, 2015

(54) SPECIAL COMPOSITION AND PROCESS FOR MAKING NUTRITIOUS DRIED FRUITS

(71) Applicant: Graceland Fruit, Inc., Frankfort, MI (US)

(72) Inventors: Nirmal K. Sinha, Frankfort, MI (US); Meena Sinha, Frankfort, MI (US); Verl C. Koski, Beulah, MI (US)

(73) Assignee: Graceland Fruit, Inc., Frankfort, MI (US)

(21) Appl. No.: 14/223,116

(22) Filed: Mar. 24, 2014

(51) Int. Cl. A23B 7/022

(52) U.S. Cl. CPC A23B 7/022; A23V 2002/00

(57) ABSTRACT

A special composition and process for making nutritious dried fruits in which the principle osmotic drying agent of the infusion solution is Trehalose. Pectinase enzyme and/or other osmotic drying agents are used in the infusion solution. The resulting dried fruits have typical natural fruit color, natural fruit flavor and softer texture. They have lower sugar content, are shelf stable and have water activity of <0.60. The use of sulfites is not necessary.

### BACKGROUND

The present invention relates to the field of infusion drying for making nutritious dried fruits. In infusion or osmotic drying, the produce which has a high water content of about 85-95% is immersed typically in a high concentration (high Brix and low water) sugar solution to partially remove water through an osmotic exchange of solutes prior to drying. Water is drawn out of the fruit, and sugar is infused into the fruit through the osmosis process. The resulting infused or osmotic dried product is further dried using various drying techniques, such as atmospheric or evaporation drying typically at temperatures of 160-185° F.

The sugars used as the osmotic drying agents are typically based on sucrose, glucose, fructose, corn syrup, high fructose corn syrup and combinations thereof. Sulfites are often to help prevent the dried fruit from turning brown. The fruit to be dried typically has a Brix of about 6-15 primarily due to naturally occurring sugars. The infusion solution typically has a sugar concentration of 60-65 Brix. The infused produce has a sugar concentration of 45-50 Brix. The initial Brix value for tart cherries is typically about 12-14. Thus, typical infusion drying can significantly increase sugar content of the infused dried cherries.

Sulfites present in commercially dried fruits can cause allergenic reactions to some individuals. The FDA requires that produces containing 10 ppm or high amounts of sulfites have to be labeled as to sulfites content. While use of sulfites or other browning inhibitors tend to reduce enzymatic browning in the dried produce, it does not inhibit Maillard type non-enzymatic browning involving reduced sugars and proteins. Thus, commercially available infused dried fruits tend to show browning and darkening.

### SUMMARY OF THE INVENTION

In the present invention, the principle osmotic drying agent of the infusion solution is Trehalose. The use of pectinase enzyme with Trehalose and/or other osmotic drying agents in the infusion solution is yet another aspect of the present invention.

These dried fruits have typical natural color, natural fruit flavor and softer texture. They have lower sugar content, are shelf stable and have water activity of <0.60. The use of sulfites is not necessary.

### BRIEF DESCRIPTION OF THE DRAWINGS

FIG. 1 shows a preferred embodiment process schematic.

### DESCRIPTION OF THE PREFERRED EMBODIMENT

In the preferred embodiment, infusion of whole, diced or sliced frozen fruits is accomplished in a surprisingly low concentration osmotic solution, containing Trehalose as the principle osmotic drying agent, and a minor amount (3-10%) of a supplemental conventional osmotic drying agent. Minor amounts of pectinase and ascorbic acid are also preferably employed. The dried fruits thus produced contain Trehalose which is reported to elicit low insulin response and provide sustained energy.

A preferred embodiment infusion solution of about 20-30 Brix includes 15-35% Trehalose as the principle osmotic drying agent, a minor amount of a supplemental drying agent, such as 5-10% juice concentrate, 0.25-1% ascorbic acid, and 0.25-0.5% pectinase enzyme. The fruit or vegetable is preferably infused for 4 hours at 90-110° F. The infused fruits are separated from the solution, and dried at 130-150° F. to a water activity of <0.60. This usually takes about 4-6 hours. The infused product typically has a Brix value of about 20.

Trehalose is reported to elicit low insulin response and provide sustained energy. Trehalose is naturally present in sunflower seeds, mushroom, etc. It can be derived from tapioca or corn starch through enzymatic process. The commercially available product is used as a food additive and is considered “Generally Recognized as Safe (GRAS) by US FDA. It is reported to have protein and membrane stabilizing properties and is used for preservation and protection of biological systems including tissues and cells. It is about 45% as sweet as table sugar.

Trehalose is a non-reducing disaccharide consisting of two glucose molecules linked by α-1-1glycosidic bond. It does not react with amino acids or proteins during processing or storage. It is stable under low pH and at elevated temperatures. Unlike sucrose, Trehalose does not readily hydrolyze. Trehalose is reported to metabolize to glucose with a balanced blood glucose response such that lower levels of glucose and insulin were observed following Trehalose ingestion compared to refined sugar.

The use of a minor amount of a supplemental osmotic drying agent contributes to a product with a softer texture and also helps the Trehalose solution lower the water activity of the dried fruits. Thus even at only 20-35 Brix, the preferred embodiment Trehalose infusion solution described above surprisingly yields a product with a water activity of <0.60. Lowering water activity to <0.60 is important to inhibit the xerophilic fungi.

Where a supplemental osmotic drying agent is used, juice concentrated is preferred. Apple juice concentrate of 70 Brix has a sugar content of about 65-68%. The sugars are primarily fructose and glucose. Thus at the preferred juice concentrated quantity of 5-10% of the infusion solution, the sugar content, which is the effective drying agent in juice concentrate, is about 4-7%. Preferably, the range of supplemental drying agent is 3-10%.

The use of a minor amount of ascorbic acid helped in creating desirable color and flavor. The use of a minor amount of pectinase enzyme in the infusion solution helps with color stability and softer texture of dried fruits.

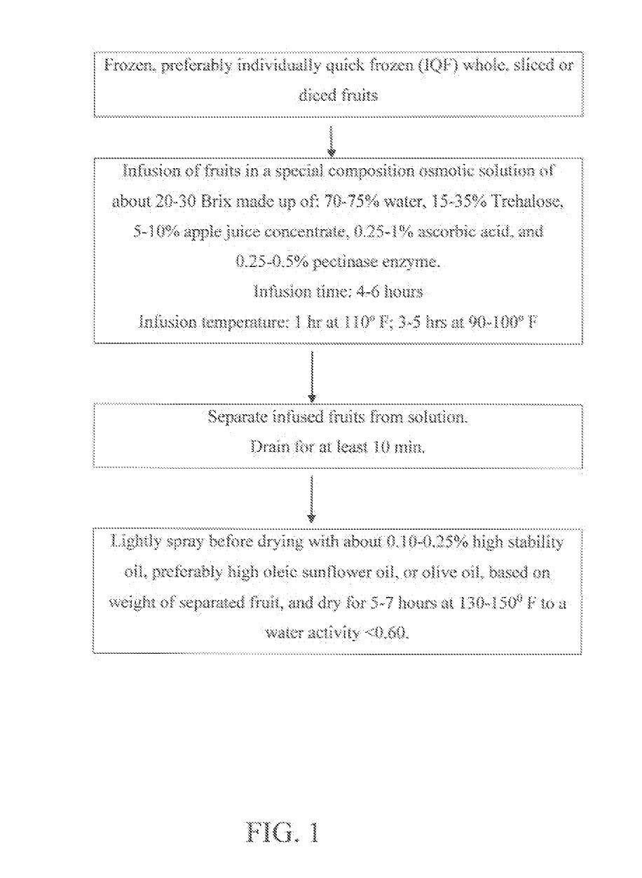

FIG. 1 outlines a preferred embodiment process and infusion solution to created nutritious dried fruits. Frozen, preferably individually quick frozen (IQF) whole, slice or diced fruits are infused in the preferred embodiment infusion solution described above for 4-6 hours at 90-110° F. Specifically, the fruit is infused for 1 hour at 110° F., and for 3-5 hours at 90-100° F. The infused fruits are separated from the infusion solution, and drained for at least 10 minutes. The fruit is then lightly sprayed before subsequent non-infusion drying, with a high stability oil, preferably high oleic sunflower oil, or olive oil. About 0.10-0.25% of oil is used based on weight of separated fruit. For example, about 0.1-0.25 Kg of oil would be used per 100 Kg of fruit. The fruit is then preferably dried for 5-7 hours at 130-150° F. to a water activity <0.60.

### EXAMPLES

Two important fruits apples and red tart cherries which are very susceptible to browning have been used in Examples 1 and 2. However, the composition and process can be used for other fruits as well. Examples 1 and 2 show the basic process parameters and infusion solutions used in accordance with the preferred embodiments disclosed herein. The results for the preferred embodiment processes are compared to market available conventionally infusion dried red tart cherries and apples having sugar content of 68-75%. Tables 1 and 2 show positive effects of the composition and process used in this application on the red color of tart cherries (Table 1), and the typical white color of dried apples (Table 2).

### Example 1

### Infusion Solution and Process Used for Dried Red Tart Whole Cherries, and Diced Apples

| | |
|---|---|
| Weight of fruit (lb) | 5.0 |
| Weight of osmotic drying solution (lb) | 16.0 |
| Weight of water (lb) | 11.25 |
| Weight of Trehalose (lb) | 3.75 |
| *Weight of apple juice concentrate (lb) | 1.00 |
| Weight of ascorbic acid (grams) | 17.25 |
| Weight of Pectinase emzyme (grams) | 11.35 |
| Infusion time (hr) and temperature (F.) | 1 hour at 110° F.; |
| | 3 hr at 90-100° F. |
| Drying time (hr) and temperature ( F.) | 4 to 5 hours at 150° F. |
| Water activity of dried fruits | 0.487-0.600 |

*Note:
Appropriate fruit juice concentrates can be used in place of apple juice concentrate. For example, in case of red tart cherries, cherry juice concentrate can be used.

### Example 2

### Same Infusion Solution and Process as Example 1, Except That Pectinase Enzyme is Not Used in the Infusion Solution

### Discussion of Results of Examples 1 and 2

The color values reported in Tables 1 and 2 are determined using the Hunter three dimensional scale. Hunter L* refers to the lightness (scale of 0-100) of the product, with 0 being black and 100 being white. Higher numbers correspond to relatively lighter and less dark products. Hunter a* refers to redness, with a higher number indicating that the product is more red. Hunter b* indicates the yellow-brown spectrum. The lower the value, the more brown the product. Higher numbers are better. Hue (h*) distinguishes among red, yellow, green and blue. Chroma (c*) is the square root of Hunter a* squared plus Hunter b* squared”. It distinguishes between vivid and dull colors.

The typical IQF cherries Hunter color values are: L*=23.5; a*=30.2; b*=13.9; c*=33.3; h*=24.7. The typical IQF diced apple Hunter color values are: L*=66.3; a*=2.0; b*=25.9; c*=26.0; h*=85.5.

TABLE 1
Effect of composition of enzymatic infusion solution
on red color of dried red tart cherries

| | | | Market sample of |
|---|---|---|---|
| | | | dried cherries |
| | Exam- | Exam- | infused with con- |
| Color values | ple 1 | ple 2 | ventional sugars |
| Hunter L* | 18.9 | 19.1 | 18.2 |
| (lightness) | | | |
| Hunter a* | 19.1 | 15.5 | 7.1 |
| (red color) | | | |
| Hunter b* | 9.16 | 6.6 | 2.9 |
| (yellow color) | | | |
| Hue | 25.5 | 23.0 | 22.0 |
| Chroma | 21.2 | 16.9 | 7.6 |
| Subjective color | Reddish color | Reddish color | Brownish red |

Note:
The red color of cherries maintained better with composition A

TABLE 2
Effect of composition of enzymatic infusion
solution on browning of dried apples

| | | | Market sample of |
|---|---|---|---|
| | | | dried apples |
| | Exam- | Exam- | infused with con- |
| Color values | ple 1 | ple 2 | ventional sugars |
| Hunter L* | 62.7 | 56.1 | 52.0 |
| (lightness) | | | |
| Hunter a* | 10.3 | 10.3 | 13.7 |
| (red color) | | | |
| Hunter b* | 40.2 | 40.4 | 39.2 |
| (yellow color) | | | |
| Hue | 75.6 | 75.6 | 70.8 |
| Chroma | 41.5 | 41.7 | 41.5 |
| Subjective color | Off white/ | Off white/ | Brown |
| | not brown | not brown | |

Note:
The typical white color of dried apples held better at high temperature storage with composition A

Thus in the case of both tart cherries and apples, the color results achieved using the preferred embodiment infusion solutions, with and without pectinase, are superior to those produced in conventionally infusion dried corresponding fruits.

The specific composition of Trehalose as the principle osmotic drying agent in infusion solution enables as to surprisingly obtain a shelf stable product (water activity of <0.60), and with this special composition infusion solution lower sugar containing infused dried products which is very important to the sugar conscious consumer are obtained. Further, our method results in a nutritious product of good color, taste and texture.

Similarly, softer texture of dried fruits and lowering of water activity was surprisingly attainable through use of the combination Trehalose, a minor amount of an additional drying agent, preferably fruit juice concentrate, and the enzyme pectinase in the infusion solution. Good color is obtained in our dried fruits, devoid of the browning which is observed in conventional sugar infused dried fruits, without the use of sulfites. Thus we achieve with the present invention dried fruits of good eating quality, which have a low sugar content (15-30%), which are softer in texture, have good fruit flavor, and which do not turn dark and brown during storage.

Of course, it is to be understood that the forgoing describe preferred embodiments of the invention, and that various changes and alterations can be made without departing from the spirit and scope of the invention as set forth in the appended claims.

1. A method for infusion drying fruit and vegetable produce comprising infusing the produce in an infusion solution in which the principle osmotic drying agent of the infusion solution is Trehalose.

2. The method of claim 1 in which the infusion solution also includes a minor amount of pectinase enzyme.

3. The method of claim 2 in which the infusion solution also includes a minor amount of a supplemental osmotic drying agent.

4. The method of claim 3 in which the infusion solution also includes a minor amount of ascorbic acid.

5. The method of claim 2 in which the infusion solution also includes a minor amount of fruit juice concentrate.

6. The method of claim 1 in which the infusion solution includes 15-35% Trehalose.

7. The method of claim 6 is which the infusion solution also includes 0.25-0.5% pectinase enzyme.

8. The method of claim 7 in which the infusion solution also includes 3-10% supplemental osmotic drying agent.

9. The method of claim 8 in which the infusion solution also includes 0.251.0% ascorbic acid.

10. The method of claim 7 in which the infusion solution also includes 5-10% fruit juice concentrate.

11. Use method of claim 6 in which the infusion solution also includes 3-10% supplemental osmotic drying agent.

12. The method of claim 6 in which the infusion solution also includes 5-10%. fruit juice concentrate.

13. The method of claim 1 in which the infusion solution also includes 3-10% supplemental osmotic drying agent.

14. The method of claim 2 in which the infusion solution also includes 5-10% fruit juice concentrate.

15. The method of claim 1 in which the produce is infused for 4-6 hours at 90110° F.

16. The method of claim 1 in which the produce is infused for 1 hour at 110° F. and for 3-5 hours at 90-100° F.

17. The method of claim 1 in which the Brix value of the infusion solution is from 20-30 Brix.

18. The method of claim 17 in which the infusion solution also includes a minor amount of pectinase enzyme.

19. The method of claim 18 in which the infusion solution also includes a minor amount of a supplemental osmotic drying agent.

20. The method of claim 19 in which the infusion solution also includes a minor amount of ascorbic acid.

21. Produce infused with an infusion solution in which Trehalose is the principle osmotic drying agent.

22. The dried product of claim 21 having a water activity of less than 0.6, and sugar content of 15-30%.
